(19) United States
(12) Patent Application Publication
(10) Pub. No.: US 2015/0351002 A1
(43) Pub. Date: Dec. 3, 2015

(54) SYSTEM AND METHOD TO CONTROL ACCESS TO THE DEVICES CONNECTED VIA M2M GATEWAY

(71) Applicant: HCL Technologies Ltd., Chennai (IN)

(72) Inventors: Tammana Uma Sankar, Noida (IN); Shivani Tomar, Noida (IN); Mayank Babu Rastogi, Noida (IN)

(21) Appl. No.: 14/722,770

(22) Filed: May 27, 2015

(30) Foreign Application Priority Data
Jun. 3, 2014 (IN) 2717/CHE/2014

(51) Int. Cl. H04W 48/02; H04L 29/06; H04W 12/08; H04W 4/00

(52) U.S. Cl. CPC H04W 48/02; H04W 4/005; H04L 65/102; H04W 12/08

(57) ABSTRACT

Disclosed herein are a method and system for providing restricted access for User Equipments to various services and functions associated with different End devices hosted by an M2M gateway. This access restriction mechanism provides means for restricting access at service level as well as at function level. Further, access restrictions can be based on various parameters such as but not limited to location, time, and user equipment.

### CROSS-REFERENCE TO RELATED APPLICATIONS

This application claims priority to Indian application no. 2717/CHE/2014 filed on Jun. 3, 2014, the complete disclosure of which, in its entirety, is herein incorporated by reference.

### TECHNICAL FIELD

The embodiments herein relate to Machine to Machine (M2M) communication networks and, more particularly, to provide restricted access for user devices to end devices through an M2M access gateway with low granularity.

### BACKGROUND

Machine to Machine (M2M) is a technology that helps wireless and wired devices of the same type. M2M technology can be used for various purposes such as warehouse management, remote control, robotics, supply chain management, Home automation, and fleet management and so on. Another prominent application of the M2M technology is in the automation systems. For example, in a home automation system, devices communicate to trigger specific actions/applications assigned to the system. The action could be anything from locking/unlocking the doors/windows, switching ON/OFF equipments such as Fan, lights and so on.

However in some scenarios it may be required to control access permissions of user devices (or users) in M2M networks. For example, in a home automation system, access permissions need to be defined such that different users possess different access rights. This helps to prevent unauthorized access to selected applications. Some of the existing systems to provide restricted access to M2M services use a mechanism of configuring access permission rules, and controlling device access based on these rules. However, these systems help to set the access permissions at a group level only and do not provide sufficient means to define rules, and control access rights at individual equipment level, which adds to convenience of user.

### SUMMARY

In view of the foregoing, an embodiment herein provides a method of controlling access of a User Equipment (UE) to End devices through a Machine-to machine gateway (M2M gateway). In this method, at least one of a service or function access request is received from the UE. Further, access permission of the UE to the requested service or function is verified based on access permissions defined and configured for that particular UE. Further, the UE is provided/denied access based on the access permissions. The method provides access control with low level granularity such that the access permission can be defined based on location, time, or UE specific rules.

Embodiments further disclose a system for controlling access of a User Equipment (UE) to End devices through a Machine-to machine gateway (M2M gateway). The system receives at least one of a service or function access request from the UE, using an access control module in the M2M gateway, and verifies access permission of the UE corresponding to the service or function, using the access control module. The system further provides or denies access for the UE to the requested function or service, based access permission rights assigned to the UE. The system provides access control with low level granularity such that the access permission can be defined based on location, time, or UE specific rules.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of access control infrastructure, as disclosed in embodiments herein;

FIG. 2 is a block diagram that depicts various components of access control module, as disclosed in the embodiments herein;

FIG. 3a is a flow diagram that depicts various steps involved in the process of defining access permissions using the access control infrastructure, as disclosed in the embodiments herein;

FIG. 3b is a flow diagram that depicts access rule structure pre-configured with the access control infrastructure, as disclosed in the embodiments herein; and

FIG. 4 is a flow diagram that depicts various steps involved in the process of controlling access to End Device through an M2M gateway using the access control infrastructure, as disclosed in the embodiments herein;

FIG. 5a is an example diagram which depicts a policy list which constitutes access rights for time based access control, as disclosed in the embodiments herein; and

FIG. 5b is an example diagram which depicts relationship between users and groups, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

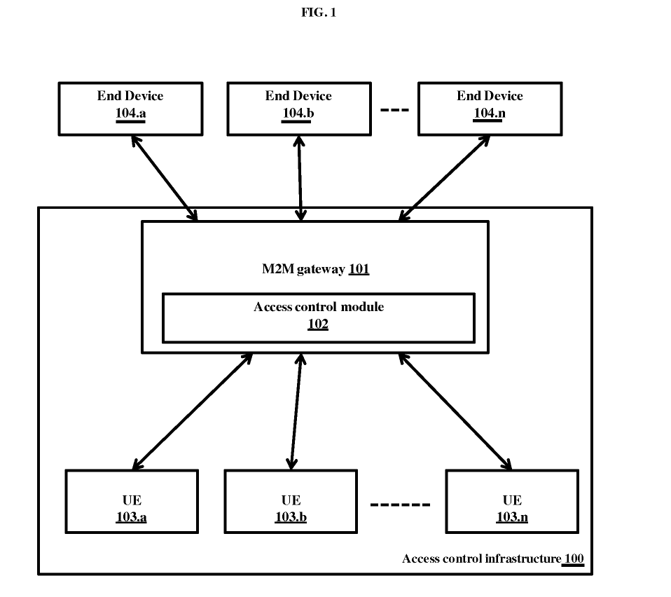

The embodiments herein disclose an access control mechanism of providing restricted access for user devices to End devices through an M2M gateway by using an access control infrastructure. Referring now to the drawings, and more particularly to FIGS. 1 through 5, where similar reference characters denote corresponding features consistently throughout the figures, there are shown embodiments.

FIG. 1 illustrates a block diagram of access control infrastructure, as disclosed in embodiments herein. As depicted in the figure, all User Equipments 103 that requires access to the End Devices 104 through M2M gateway (gateway) 101 are connected to the gateway 101 using any suitable wireless access technologies supported by the network. The access control module 102 present in the M2M gateway 101 possesses information regarding various access control permissions assigned to a User Equipment (UE) 103 or a group of UEs 103.

When a UE 103 requests gateway access to a particular service or function of a particular end device 104, hosted by the M2M gateway 101, the access control module 102 receives request from the UE 103 and checks whether the UE 103 has access permission to the requested service/function/device. In a preferred embodiment, the access control module 102 checks access permission of the UE 103 to a selected Device/service/function based on pre-configured rules. In another preferred embodiment, the rules are defined and configured such that access to the End Devices 104 through the M2M gateway 101 and can be controlled with low level granularity. This helps to set access control permissions at group level, individual user device/equipment level and also facilitates access restriction for specific end device at service level, and at specific function level.

If the UE 103 is found to have permission to access the specific Device/service/function, then the access control module 102 allows the UE 103 to access the M2M gateway 101 and connected End Devices 104. If the UE 103 is found to have no permission to access the specific Device/service/function, then the access control module 102 denies access for the UE 103 to the M2M gateway 101.

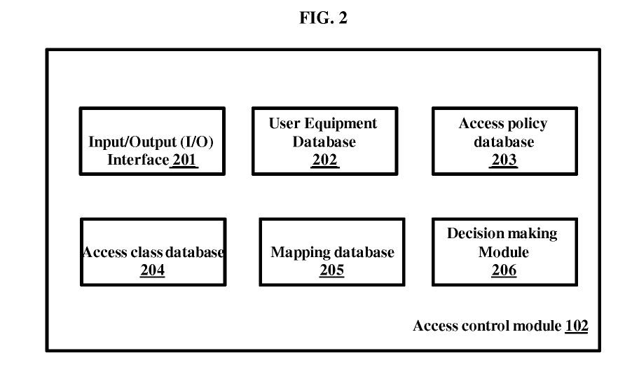

FIG. 2 is a block diagram that depicts various components of access control module, as disclosed in the embodiments herein. The access control module 102 further comprises of an Input/Output (I/O) Interface 201, a User Equipment database 202, an access policy database 203, an access class database 204, a mapping database 205, and a decision making module 206.

The I/O interface 201 facilitates communication between the access control module 102 and all UEs 103 connected to the M2M gateway 101. The access request from a UE 103 is collected using the I/O interface 201, which in turn is passed on to the decision making module 206. The user equipment database 202 possesses information regarding UEs 103 which are connected to, and configured with the M2M gateway 101. The UE specific information may include but not limited to unique identification data specific to each UE 103. The access policy database 203 is used to store information related to all access policies pre-defined and configured by an authorized person such as an administrator. Each access policy defines certain level of access to selected Device(s), Service(es) and/or function(s) such that a UE 103 or a group of UEs 103 can be provided/denied access to a selected Devices/Services/function hosted by the M2M gateway 101 based on the access permissions defined by access policy assigned to that particular UE or UE group.

The access class database 204 is used to store information regarding access class(es) defined and configured with the access control module 102. The access class is a group to which one or more UE 103 can be assigned so that selected access policy can be collectively applied to the UEs 103 in the access class. The mapping database 205 may be used to store mapping information, wherein the mapping information defines association of various access policies, access classes, and individual UEs 103.

The decision making module 206 collects information from the user equipment database 202, access policy database 203, access class database 204, and mapping database 205, processes the collected information, and decides whether to approve/deny access request from a UE 103 to a specific service/function.

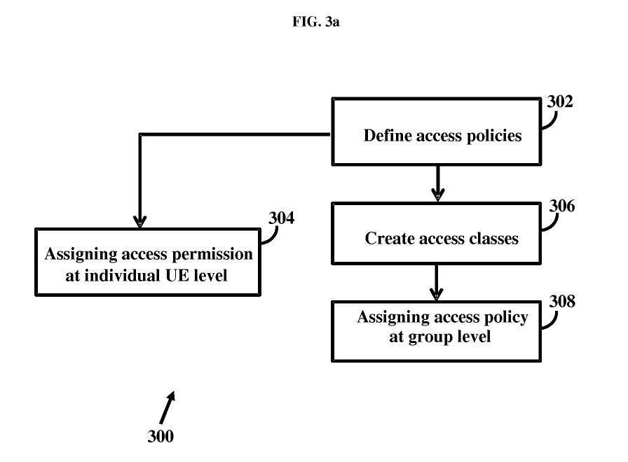

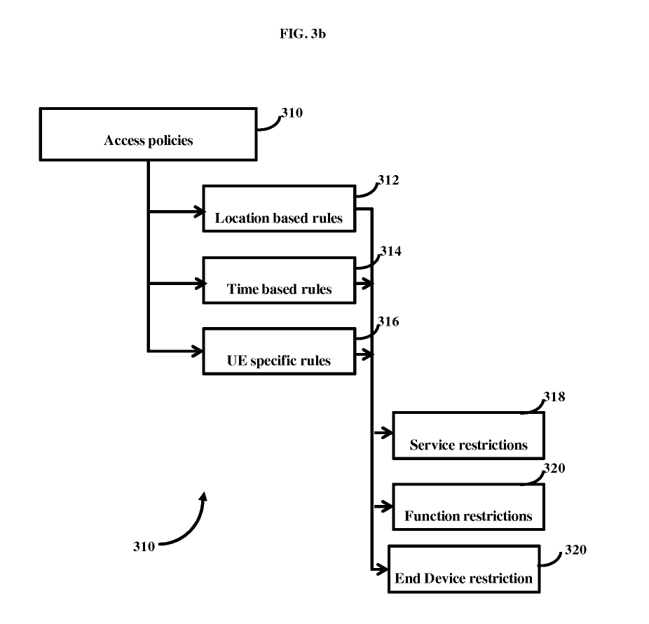

FIG. 3a is a flow diagram that depicts various steps involved in the process of defining access permissions using the access control infrastructure, as disclosed in the embodiments herein. Option to assign access permissions at the group level helps to assign a selected rule to multiple UEs 103 together. First step is to create or define (302) policy. At least one access policy is defined. The access policy comprises of rules/settings which define access permission of the UE 103 to which the access policy is applied, to various Devices, services and functions hosted by the M2M gateway 101. It can be bifurcated here either create Access Classes or Access permission at individual level. The access control infrastructure 100 provides means for restricting M2M gateway access for UEs 103 based on pre-configured rules, with the flexibility of assigning/setting rules at individual UE level or at a group level.

First step in assigning rules at the group level is creating (306) access classes. The access class is a group of UEs 103 for which same access policies are to be assigned. The total number of UEs 103 that can be assigned to a single access class may be configured to vary based on requirements and capabilities of the M2M gateway 101.

Further, selected access policy is assigned (308) to selected access class. In an embodiment, only one access policy may be assigned to one access class. In another embodiment, multiple access policies may be assigned to each access class. When a specific access policy is assigned to a selected access class, access permission of all UEs 103 are restricted based on rules associated with that particular access policy. In same way, the user may choose to assign at least one access policy to a selected UE 103 at individual UE level (304). In an embodiment, access policy assigned at the group/access class level can be overridden by access policy assigned at individual UE level. In another embodiment, access policy assigned at the individual UE level may be overridden using access policy assigned at group/access class level. The various actions in method 300 may be performed in the order presented, in a different order or simultaneously. Further, in some embodiments, some actions listed in FIG. 3a may be omitted.

FIG. 3b is a flow diagram that depicts access rule structure pre-configured with the access control infrastructure, as disclosed in the embodiments herein. The access policies provided by the access control infrastructure 100 are designed to provide access restrictions to the M2M gateway 101 with low level granularity. The access policies support multi-dimensional access restriction i.e. access restriction based on at least one of or a combination of location, time, and User Equipment parameters. Further it can be extended to include access restrictions for other parameters. Access permissions can be set levels as low as function level such that though a UE 103 has access permission to a particular function associated with a particular service of a particular end device 104 hosted at the M2M gateway 101.

A plurality of policy lists, each comprises of list of all access rights defined for specific dimension, are generated. For example, one policy list may be specific to rules defined for location (312) based access restriction. Similarly, separate policy lists may be created specific to rules defined based on other parameter such as time (314), user equipment (316) and so on.

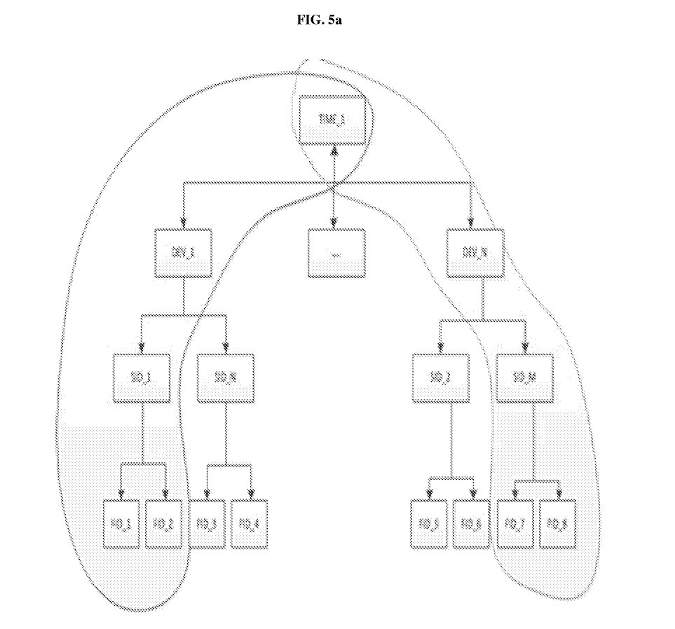

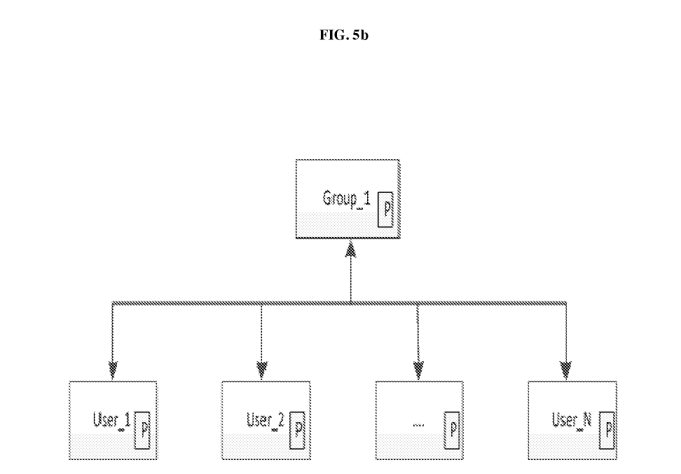

As depicted in the FIG. 5a, rules may be defined and arranged in tables and sub-tables format such that access to sub-tables can be governed by the policy rule table which defines policy rules for each dimension, and total number of sub-tables depends upon number of policies, and number of dimensions.

Another important component of the access rule structure is relationship defined between UEs (which indirectly refers to specific users) 103, access classes (groups), and access policies. The access control module 102 uses this information to permit/deny access when a UE 103 sends a Device/service/function access request to the M2M gateway 101. In an embodiment, same UE 103 may have rules assigned at group level as well as individual UE/user level. In such scenarios, overriding conditions may be defined based on which one out of the multiple rules assigned to a UE 103 overrides other rules in a particular scenario. An example illustration of relationship between users and groups is depicted in FIG. 5b.

In a preferred embodiment, the access policies (rules) and UE information may be mapped using unique identification numbers associated with them. Consider an example implementation scenario of the rule based access control mechanism with a home automation system.

Consider that in the home automation system, services to be controlled are light service, and curtain controller service. Table below depicts the way selected services are mapped against corresponding unique ID values.

TABLE 1

| Service | ID |
|---|---|
| Light Service | S1 |
| Curtain controller Service | S2 |

Now for each service selected, functions that need to be controlled can be defined. Table below depicts the way selected functions corresponding to selected services are mapped against corresponding unique ID values.

TABLE 2

| Service ID | Functionality | Functionality ID |
|---|---|---|
| S1 | Get light status | F1 |
| S1 | Set lights ON | F2 |
| S1 | Set lights OFF | F3 |
| S1 | Set dimmer level | F4 |
| S2 | Get curtain status | F1 |
| S2 | Open curtain | F2 |
| S2 | Close curtain | F3 |
| S2 | Stop curtain | F4 |

The access control system allows setting access restriction based on location of the End Device 104 or UE 103 which requests access to the service. Table below depicts the way selected locations are mapped against corresponding unique ID values.

TABLE 3

| Service | ID |
|---|---|
| Light Service | S1 |
| Curtain controller Service | S2 |

Similarly, the system may permit/deny access to the selected service based on time at which the request is made by the UE 103. Table below depicts the way permitted time options are mapped against corresponding unique ID value.

TABLE 4

| Time Interval | Id |
|---|---|
| Morning | T1 |
| Evening | T2 |

Another parameter the system may consider to permit/deny access for the UE 103 to a particular service is the unique ID associated with each UE i.e. the system may be configured to permit access for certain UEs 103 to selected services, while restricting other UEs 103 from accessing the same service. Table below depicts the way permitted UE information and corresponding unique ID values are stored in the database.

TABLE 5

| Controller | Id |
|---|---|
| Mobile1 | C1 |
| Mobile2 | C2 |

Now, the system requires information regarding access policy assigned to the UEs 103. In various embodiments, the access policies may be assigned at group level or individual UE level, and this data may be saved in separate tables as depicted below.

TABLE 6a

| Groups | Policies |
|---|---|
| G1 | P1 |
| G2 | P1 |
| G3 | P2 |
| G4 | P3 |

TABLE 6b

| Users | Policies |
|---|---|
| U1 | P1 |
| U2 | P2 |

Now, a policy rule table contains mapping between policy ids and rules applicable on different dimensions selected i.e. time, location, and user equipment in the specific application scenario considered. Table given below depicts the way the mentioned information is mapped in a database.

TABLE 7

| Policy | | | Control | |
|---|---|---|---|---|
| id | Time | Location | device | Comments |
| P1 | * | * | * | The associated subject has |
| | | | | constraints on some instances |
| | | | | of time, some instances of |
| | | | | Locations and some instances |
| | | | | of Controlling device. |
| P2 | 1 | 1 | 1 | The associated subject has |
| | | | | constraints on all instances of |
| | | | | time, all instances of |
| | | | | Locations and all instances of |
| | | | | Controlling device. |
| P3 | 0 | 0 | 0 | The associated subject is |
| | | | | allowed to operate on all |
| | | | | devices at all times in all |
| | | | | locations for all controller |
| | | | | devices. |
| P4 | 0 | 1 | * | The associated subject has no |
| | | | | constraints on time. It has |
| | | | | constraints on all instances of |
| | | | | location. It also has |
| | | | | constraints on some instances |
| | | | | of Controlling device. |

Where,

TABLE 8

| * | There are some constraints for specific instances of selected |
|---|---|
| | dimension. |
| 0 | There are no constraints on any instance of selected |
| | dimension. |
| 1 | There are constraints for all instances of selected dimension. |

When access policies mentioned in table 7 are applied to UEs 103 either at user level or at group level, then access of the UEs 103 to the selected Device/services/functions is restricted according to rules/settings configured in the policy rule table depicted in table 7.

For example, the next level policy table for Table. 7, with time constraints (*) can be represented as:

TABLE 9
P1-Time Policy table

| Time | D | S | F | Allow | Comment |
|---|---|---|---|---|---|
| T1 | D1 | S1 | F1 | 0 | The associated subject is not allowed to |
| | | | | | Get Light status at time T1 for Light D1 |
| T1 | D1 | S1 | F2 | 1 | The associated subject is allowed to |
| | | | | | Switch on Light at time T1 for Light D1 |
| T2 | 0 | S2 | F2 | 1 | The associated subject is allowed to Open |
| | | | | | curtains at time T2 for All curtains except |
| | | | | | for the devices those are present in the list |
| | | | | | for the same time and same service and |
| | | | | | functionality. |
| T3 | D1 | 0 | 0 | 0 | The associated subject is not allowed to |
| | | | | | control at time T3 for Device D1 for all |
| | | | | | services and functionalities except for |
| | | | | | the services those are present in the list. |
| T3 | 0 | 0 | 0 | 0 | The associated subject is not allowed to |
| | | | | | control any device at time T3 for all the |
| | | | | | devices except for the devices, services |
| | | | | | present in the list. |

Where, rules for “Allow” are:
0 → Not allow
1 → Allow

As is evident from the table, access permission of device 1 (D1) is different for different functions associated with the functions F1, and F2 of the service S1. This feature helps to control device access to the M2M gateway 101 and associated services and specific functions with low level granularity. Similar way, access permission for different services, and functions can be restricted based on factors such as but not limited to location, time, and UE. The various actions in method 310 may be performed in the order presented, in a different order or simultaneously. Further, in some embodiments, some actions listed in FIG. 3b may be omitted.

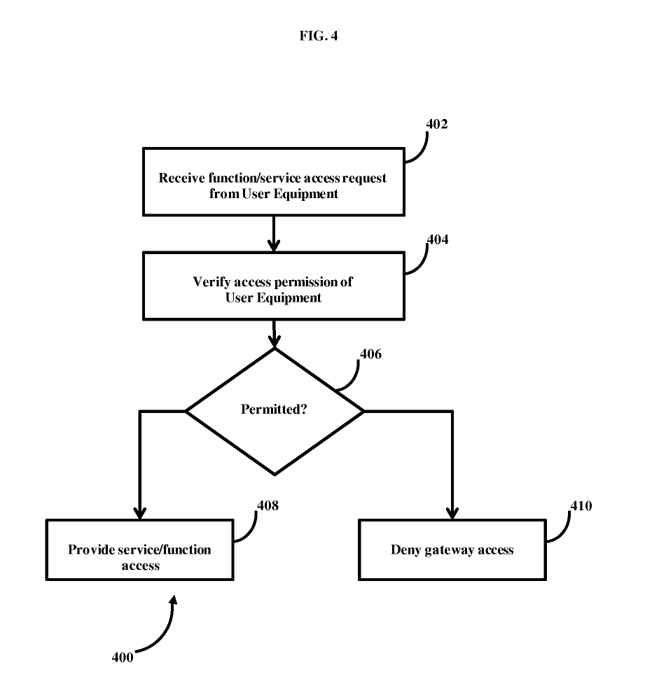

FIG. 4 is a flow diagram that depicts various steps involved in the process of controlling access to End Device through an M2M gateway using the access control infrastructure, as disclosed in the embodiments herein. Once the access control settings i.e. access class, access policies, and association between the access classes, UEs 103, and access policies are defined, the access control module 102, based on the access policies and the associations defined, controls access of UEs 103 to the M2M gateway 101.

When a UE 103 sends an access request to any service or any specific function associated with a service of any end device 104, the access control module 102 receives (402) the request via the I/O interface 201. Further, the decision making module 206 in the access control module 102 processes the access request received from the UE 103 to verify (404) whether the UE 103 has got permission to access the requested Device/service/function or not. The decision making module 206 may compare a unique identifier of the UE 103 that sent the request with the mapping database 205 that stores access permissions assigned to the UE 103 or an access class the UE 103 belongs to.

If the UE 103 is found to have required access permissions, then the access control module 102 provides (408) gateway access to the UE 103. If the UE 103 is found not to have required access permissions, then the access control module 102 denies (410) gateway access to the UE 103. The various actions in method 400 may be performed in the order presented, in a different order or simultaneously. Further, in some embodiments, some actions listed in FIG. 4 may be omitted.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiments disclosed herein specify a system for providing restricted access for User Equipments to an End Device through an M2M gateway. The mechanism allows rule based access to the M2M gateway with low level granularity, providing a system thereof. Therefore, it is understood that the scope of protection is extended to such a system and by extension, to a computer readable means having a message therein, said computer readable means containing a program code for implementation of one or more steps of the method, when the program runs on a server or mobile device or any suitable programmable device. The method is implemented in a preferred embodiment using the system together with a software program written in, for ex. Very high speed integrated circuit Hardware Description Language (VHDL), another programming language, or implemented by one or more VHDL or several software modules being executed on at least one hardware device. The hardware device can be any kind of device which can be programmed including, for ex. any kind of a computer like a server or a personal computer, or the like, or any combination thereof, for ex. one processor and two FPGAs. The device may also include means which could be for ex. hardware means like an ASIC or a combination of hardware and software means, an ASIC and an FPGA, or at least one microprocessor and at least one memory with software modules located therein. Thus, the means are at least one hardware means or at least one hardware-software means. The method embodiments described herein could be implemented in pure hardware or partly in hardware and partly in software. Alternatively, the embodiment may be implemented on different hardware devices, for ex. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method of controlling access of a User Equipment (UE) to End devices through a Machine-to machine gateway (M2M gateway), said method comprises of:
receiving at least one of a service or function access request from said UE;
verifying access permission of said UE corresponding to said at least one of the service or function;
providing access for said UE to said function or service if said UE possesses required access permission; and
denying access for said UE to said function or service if said UE does not possess said required access permission.

2. The method as claimed in claim 1, wherein said access permission is defined based on at least one access classes assigned to said UE.

3. The method as claimed in claim 2, wherein said at least one access class is assigned to said UE at a group level.

4. The method as claimed in claim 3, wherein assigning said at least one access class at said group level further comprises of:
creating at least one access class;
adding at least UE to said access class; and
assigning at least one access policy to said access class.

5. The method as claimed in claim 4, wherein said access class defines access permission for said UE based on at least one of a plurality of location based, or time based rules.

6. The method as claimed in claim 2, wherein said at least one access class is assigned to said UE at an individual device level.

7. The method as claimed in claim 1, wherein access permission of said UE is restricted based on at least one of an end device level, service level, or function level restrictions.

8. A system for controlling access of a User Equipment (UE) to End devices through a Machine-to machine gateway (M2M gateway), said system configured for:
receiving at least one of a service or function access request from said UE, using an access control module in said M2M gateway;
verifying access permission of said UE corresponding to said at least one of the service or function, using said access control module;
providing access for said UE to said function or service if said UE possesses required access permission, using said access control module; and
denying access for said UE to said function or service if said UE does not possess said required access permission, using said access control module.

9. The system as claimed in claim 8, wherein said access control module is further configured to define said access permission based on at least one access class assigned to said UE.

10. The system as claimed in claim 9, wherein said access control module is further configured to provide means for assigning at least one access class to said UE at a group level.

11. The system as claimed in claim 10, wherein said access control module is further configured to provide means for assigning said at least one access class at said group level by:
creating at least one access class using said access control module;
adding at least UE to said access class, using said access control module; and
assigning at least one access policy to said access class, using said access control module.

12. The system as claimed in claim 11, wherein said access control module is further configured to provide said access permission for said UE based on at least one of a plurality of location based, or time based rules as defined by said access class.

13. The system as claimed in claim 9, wherein said access control module is further configured to provide means for assigning said at least one access class to said UE at an individual device level.

14. The system as claimed in claim 8, wherein said access control module is further configured to restrict access permission of said UE based on at least one of an end device level, service level, or function level restrictions.
